(19) United States
(12) Patent Application Publication
(10) Pub. No.: US 2021/0383715 A1
(43) Pub. Date: Dec. 9, 2021

(54) SYSTEM AND METHOD FOR AUTOMATIC CALIBRATION OF READABILITY OF READING MATERIAL AND THE READING ABILITY OF A READER

(71) Applicant: Deepesh Arora, Austin, TX (US)

(72) Inventor: Deepesh Arora, Austin, TX (US)

(21) Appl. No.: 16/891,120

(22) Filed: Jun. 3, 2020

(51) Int. Cl. G09B 17/00; G09B 5/02; G09B 5/08

(52) U.S. Cl. CPC G09B 17/003; G09B 5/08; G09B 5/02

(57) ABSTRACT

The systems and methods discussed in this invention are about a computer aided system which is used for automatically calibrating reading material by taking into account a plurality of attributes in order to develop a readability index of that reading material. This invention also uses a computer aided system, which automatically and continuously, calibrates and assesses a person's reading ability. This is done based on the reading material(s) that the person has read or is reading, along with that, the person's comprehension of the reading material and a plurality of other inputs including but not limited to genres, areas of interests that the system receives.

### BACKGROUND OF THE INVENTION

Research has shown that reading has a phenomenal impact on brain development. It is a visual exercise that helps enhance a person's ability to process visual information. Reading is also a great activity to expand knowledge, vocabulary and cognitive abilities. Regular reading also is known to help keep the brain stimulated and could be a habit that can help avoid disorders such as dementia and even conditions such as Alzheimer's.

However, in today's age of heavy exposure to high technology media and the internet, the practice of reading is on a decline.

This invention aims to use scientific methods and computer aided technology to encourage a reader to discover new reading material that aligns with their interests, reading levels, comprehension abilities and personal reading goals.

Further, this invention aims to encourage readers to read regularly and to challenge readers into reading material of increasing complexity. The system's goal is to scientifically support the reader into elevating their reading proficiency and cognitive abilities through regular training & practice.

### BRIEF SUMMARY OF THE INVENTION

The present invention relates to a system and method that automatically calibrates reading material and readers for determining a readability index of the material and a reading ability score of the reader.

Another aim of the invention is to calibrate a reader's reading level and scientifically support & encourage the reader in improving their reading ability. This invention aims to create a system for automatic calibration of reading material based on this systems assessment of the readability of the reading material along various categories or vectors of classification including but not limited to genre, writing style, mood, topics of interest, subject, field of work, author etc.

The invention also aims to determine the reading ability of readers by analyzing the reading material(s) that they have read knowledge of the readers, areas of reader's interests, reading materials vectors of classification. And metrics including but not limited to reader's comprehension, speed of reading, reading pattern and a plurality of other factors when it comes to the suggested reading materials.

### BRIEF DESCRIPTION OF THE DRAWING

FIG. 1 describes the reader's reading feedback and evaluation system.

FIG. 2 describes method of calibrating a reader's reading ability.

FIG. 3 describes method of recommending reading material for the reader.

FIG. 4 describes the method for calibrating reading material.

FIG. 5 describes the reading incentive system.

FIG. 6 describes the system overview.

### DETAILED DESCRIPTION OF THE INVENTION

Computer aided system means and includes computers, laptops, mobile phones, cloud computing systems and any computing systems that possess computational power.

Reader means a person whose information is sent to the system for processing and providing a reading ability score. A reader may or may not be the user who interacts with the interaction system. A reader can be a person at any reading level. Readers could be any person who is learning to read (ie. they do not currently understand the meaning behind printed words) or has already built a reading proficiency at various levels.

Reading material means material that can be read or interpreted by a reader including but not limited to material that contains pictures, illustrations, words or combinations thereof. The material may be available in various formats such as print or digital media. Examples of reading material may include and are not limited to books, magazines, storybooks, emails, passages etc.

Readability measure is any of the various measures of a reading material. A readability measure attempts to provide guidance on a reading material's use such as it's reading or comprehension or other measures based on a variety of factors that are specific to such measures.

Calibrated reading material means material for which one or more readability measures are available prior to the time of such reading material to be processed using the systems and methods specified in this invention. The publicly available readability measures include but shall not be limited to one or more of Lexile scores, Guided Reading Level scores, Grade Levels or other measures. Most such measures as the above have been developed by various organizations and may be the trademark or intellectual property of such organization where applicable. Uncalibrated reading material is the material which does not fall in the definition of Calibrated reading material.

Readability Index means and includes the calibrated measure of a reading material as determined using the systems and methods defined in this invention.

Reading ability score means and includes the reader's level of reading ability and comprehension of a reading material as determined using the systems and methods defined in this invention.

Reading Log means and includes the collection of information about records of a reader's various reading sessions including but may not be limited to the name of the reading material, information about the content that was read such as word count or pages count or other means, the amount of time the reader took to read the content and a brief description of the users interpretation or comprehension of the reading material/content read by the reader.

Incentive means and includes methods used to offer appreciation or encouragement to the reader to keep the readers motivated about reading regularly.

Reader evaluation system means and includes the system which helps to understand the reading level the reader by taking into account attributes including but not limited to the reader's levels of enjoyment and comprehension of the material. This is including but not limited to past information data, past comprehension levels, current reading material data. This information helps to give the reader a proper reading material.

Reading material recommendation system means and includes a system which suggests reading material for a reader based on the systems' measure of a reader's reading ability and with a goal to help the reader improve their reading ability & comprehension of reading material

Reading material evaluation system means and includes the system which evaluates reading material for its readability based on an assessment of the reading ability of the readers who have read and comprehended the reading material.

Target means and includes an aim for the reader to complete with respect to the reading material(s). This will help to decide the types of incentives that the reader will get.

Goal means and includes the desired result with respect to the reading material(s) that the reader achieves.

Challenge means and includes a task that the reader gets to complete a specific target with respect to the reading material(s). A challenge is a type of incentive.

Reward means and includes the incentive that the reader gets upon finishing the target reading material(s). A reward is a type of incentive.

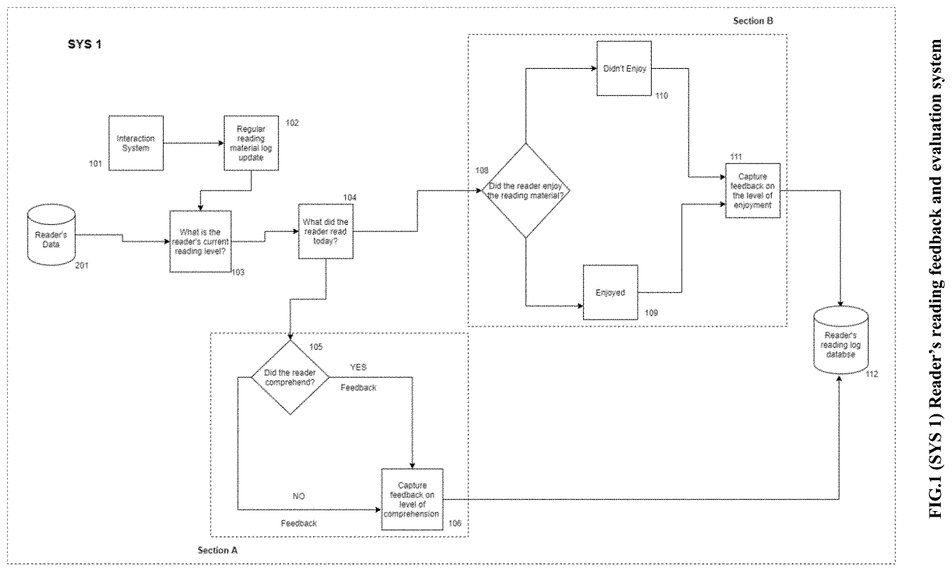

FIG. 1 describes the reader's reading feedback and evaluation system (SYS 1). The reader or user via the interaction system provides updates of material that the reader has read in a reading session. This reading material log update system (102) gathers information about the reader's current reading level (103) from the reader's data database (201). In addition, the reading material log update system (102) captures information about what the reader read during that reading session (104) and specifically captures input about the reader's comprehension (A) and the reader's enjoyment level (B), as shown in section B and section A of FIG. 1. The reader feedback and evaluation system stores the data gathered in (105) and (108) into the reader's reading log database (112).

For example, a 7 year old child has completed reading 15 pages today. An adult interacts with the system and updates the system with the reader's reading log. The system already has past information about the reader from the reader's data database. As a part of updating the reading log, the reader now provides data about that reading session (15 pages today) and inputs into the system a plurality of information including the reader's level of comprehension and enjoyment. The information provided is stored into the reader's reading log database.

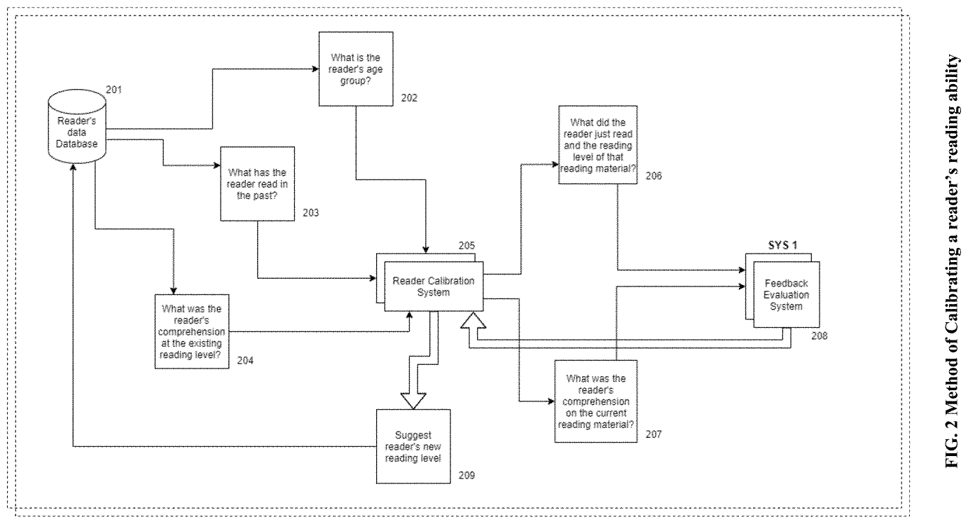

FIG. 2 describes the method of calibrating a reader's reading ability. For the calibration of the reader's reading ability, various attributes are taken into consideration. The reader's data database (201) provides with different sets of information about the reader which is stored in that database. It begins with providing the age group that the reader belongs to (202), it further gives information about the reader's past reading material and their level of reading (203) and lastly it provides with the comprehension level of the reader with respect to their current reading level (204). All these attributes are sent to the reader's calibration system (205). To calibrate the reader's reading ability, the reader's calibration system (205) enquires about the reader's current reading material and the level of that reading material (206). It further asks about the reader's level of comprehension of the current reading material (207). This data gets stored in the feedback evaluation system (208). After the data is gathered from 206 and 207, the feedback evaluation system (208) forwards this data to the reader's calibration system (205). Once the information is stored in the reader's calibration system (205), it suggests the reader's new reading level (209), based on comparative evaluations of comprehension of past reading materials and current reading material and also an evaluation of how much reading material has been read by the reader at the current reading level. This information is then stored in the reader's data database (201) where the new reading level of the reader is stored.

For example, if our 7 year old reader is reading every day, they are making inputs into (SYS 1) each time they complete a reading session. All inputs from (SYS 1) are sent to the reader's calibration system (205) for evaluation, each time an input is received. The reader's calibration system takes into account the most recent inputs and compares that to the calibration system's existing measure of the readers reading level. The reader's calibration system (205) then interacts with the feedback evaluation system (208) to understand the reader's comprehension and enjoyment levels with respect to the current information that it receives. Based on that information, the reader's calibration system (205) suggests a new reading level for the reader, which further gets stored in the reader's data database (201).

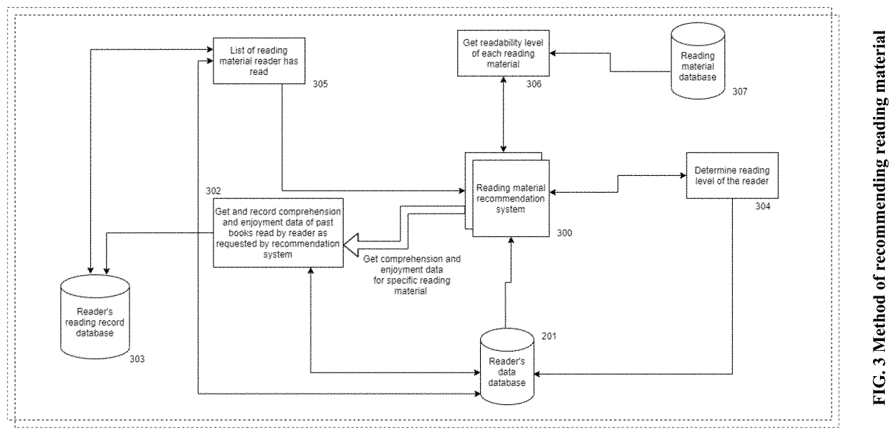

FIG. 3 describes the method of recommending reading material for the reader. This reading material recommendation system (300) first begins with assessing stored data about the reader from the reader's data database (201), also processing data from the reader's reading record database (303), of the reading material that the reader has read before (305). Of all of this reading material that the reader has read, the reading material recommendation system gathers a plurality of metrics including but not limited to comprehension and enjoyment data (302) for a selected subset of reading materials (as determined by the reading material recommendation system) that the user has read. For each of these reading materials, the system also gathers the systems measure of readability level of that reading material (306) from the reading material database (307). The system then uses all the above data among other factors to compute and determine its estimation of the current reading level of the reader (304) and stores this information back in to the reader's data database (201).

For example, for our 7 year old reader, his basic information along with his past reading information (305) is gathered and assessed by the reading material recommendation system (300). The reading material recommendation system also assesses other metrics such as the comprehension and enjoyment data of the reader's past reading log records. It then uses a selected subset or all of this accumulated data to compute and suggest the current (updated) reading level of our 7-year-old reader. Based on this updated reading level, the system now looks up reading material from the reading material database and recommended reading material to the reader which is within a reasonable range of the readers updated reading level

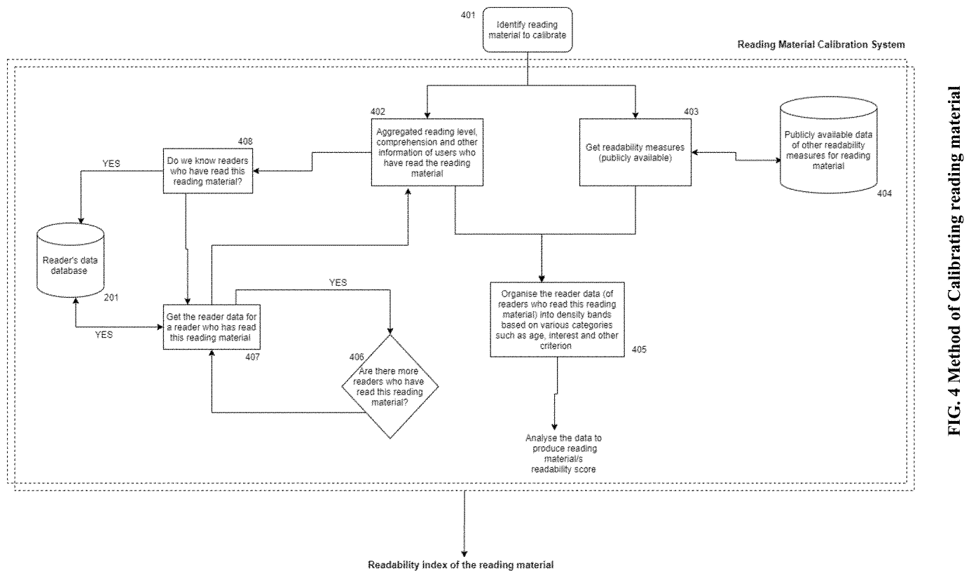

FIG. 4 describes the method for calibrating reading material. The method begins with the system being provided with or the system identifying through one or more means specific reading material to calibrate (401). The system first gets publicly available readability measures for such reading material (403) from a variety of sources which have information of readability measures of given reading material (404). In parallel, the system first checks if it has information about users who have read this reading material (408) and if such users are found in its database, it gets aggregated reading information including reading level, comprehension, enjoyment and other information of readers who have read such reading material (402) from the reader data database (201). After combining the above information, the reading material calibration system organizes the reader data into groups or density bands to determine groups of readers based on one or more attributes such as age, comprehension levels, enjoyment levels and other combinations thereof in order to analyse the information. The system based on its analysis now produces a readability index of the reading material.

For example, the system has been tasked with calibrating a reading material which has been read by various readers in our system. The system first begins with retrieving the publicly available readability measures of such reading material and establishes a “base-lined readability index” for the reading material. Since the reading material has been read by multiple readers in our system, the system retrieves data from our reader's data database (201) on prior reading records of readers reading such reading material.

Upon retrieving data from our reader's data database (201), the system determines that the reading material has been read by 9-13 year old readers with varying degrees of comprehension and enjoyment. By further analysis (statistical and other models), the system determines that the reading material is most appropriate for readers with a given reading ability score (for simplicity of discussion, let us assume that the reading ability score is typical of readers in the 11 to 12 year old age group). The system then calibrates the reading material to a readability index that matches such target reader's reading ability score. The reading material calibration system now compares the “estimated readability index” to the “base-lined readability index” and stores both metrics into its reading material database (307) for future retrieval. The systems calibration of the reading material is the “estimated readability index” as determined by the reading material calibration system.

For example, the reading material calibration system has been tasked with calibrating a reading material that has not been read by any user in our system. The system first begins with retrieving the publicly available readability measures of such reading material and establishes a “base-lined readability index” for the reading material. Since the reading material has not been read by any user in our system, the calibration system will simply assume that the “estimated readability index” is at the same level as the “base-lined readability index”. Every time a reader completes reading a reading material in our system, that readers reading ability score is re-computed by the reader's calibration system (205). In addition, the reading material is re-calibrated based on this new data by the reading material calibration system. The reading material calibration system will at each time when a reader completes reading such material re-compute and record its estimate of the “estimated readability index” of the reading material.

For example, the system has been tasked with calibrating a reading material for which no publicly available readability measure is available. Since the publicly available readability measure is not available, the system will assume that the “base-lined readability index” of the material is not available. The system will now compute the “estimated readability index” of the reading material based on information that it has within its databases and record such data in its reading material database (307). The reading material calibration system will at each time when a reader completes reading such material re-compute and record its estimate of the “estimated readability index” of the reading material.

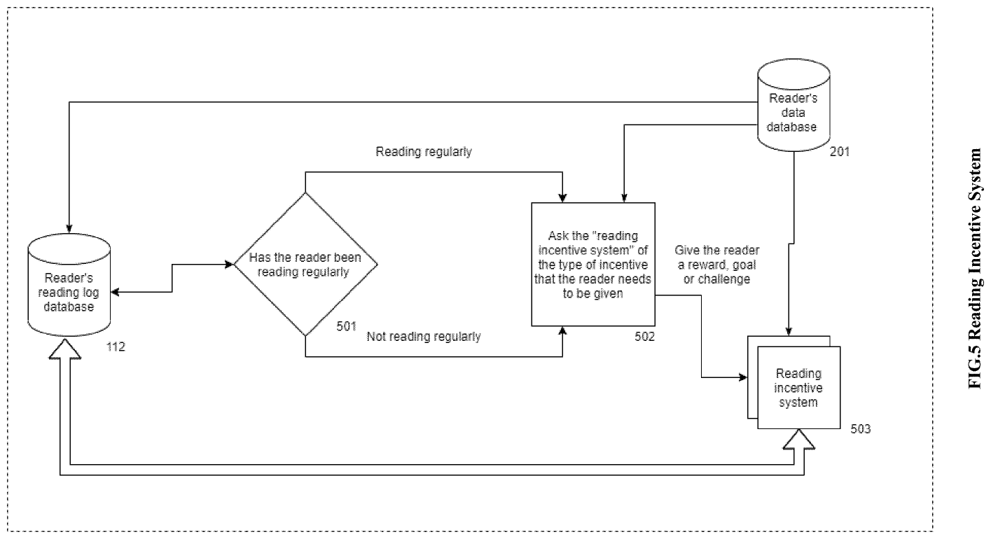

FIG. 5 describes the reading incentive system. In this figure, the reader's reading log database stores information about the reader's past readings and interacts with the reader if they have been reading the reading material regularly (501). If the reader has been reading regularly, the system then identifies the type of incentive to be given to the reader (502) and interacts with the reading incentive system (503). Similarly, if the reader does not read regularly, the type of incentive that they receive will be decided by the reading incentive system (503).

The reading incentive system (503) gathers stored data from the reader's data database (201), including but not limited to the age of the reader, the interests of the reader, their past reading records. This information helps the reading incentive system (502) to decide on the type of incentive to be given to the reader. Once the type of incentive is selected, that data about the reader gets transferred to the reader's reading log database (112).

For example, A user sets a goal to read 3 books in a month's time. For a non-reader setting such goals will ensure that he enhances his reading. The system will store this goal and help the reader achieve the same by constantly reminding the reader of his goal/target. A reward for this accomplishment would push the user further to fulfil it. Therefore according to the user's profile and interests the system will provide for a reward for the user once he fulfils his target or goal.

It is also essential to understand that, for improving reading habits of the users without targets, certain motivation is necessary. The system ensures this by having various kinds of incentives. These could depend on age and other factors.

For example, if a user manages to continuously read for 4 days every week, a reward shall be given to the reader to appreciate their effort and help them to read more. Similarly, if a user manages to finish a particular book in a record time or has finished this book in lesser time than the previous one, she can be given an incentive to recognize her efforts.

The system also aims to provide various challenges to keep the reader engaged.

Therefore the system can set certain targets to be completed and reward such users with coupons, discounts, free products or other incentives. This encourages and motivates users to explore reading more.

In another example, suppose a non-reader joins the system to start reading and develop it as a habit. The system by understanding the records of reading can conclude that the reader reads an average of 5 pages in a day. When the system observes that the user has developed a pattern, it may provide an incentive (203) to the user to now stretch themselves for reading 8 pages a day. This would help the user to feel motivated and accomplished.

In yet another example, if a reader who typically reads 5 pages a day has now read 9 pages today would get an unexpected reward in the form of a free ice cream scoop. This creates in the reader an innate drive to read more. This drive is created by the anticipation of more potential rewards down the line if the reader is to stretch himself from time to time.

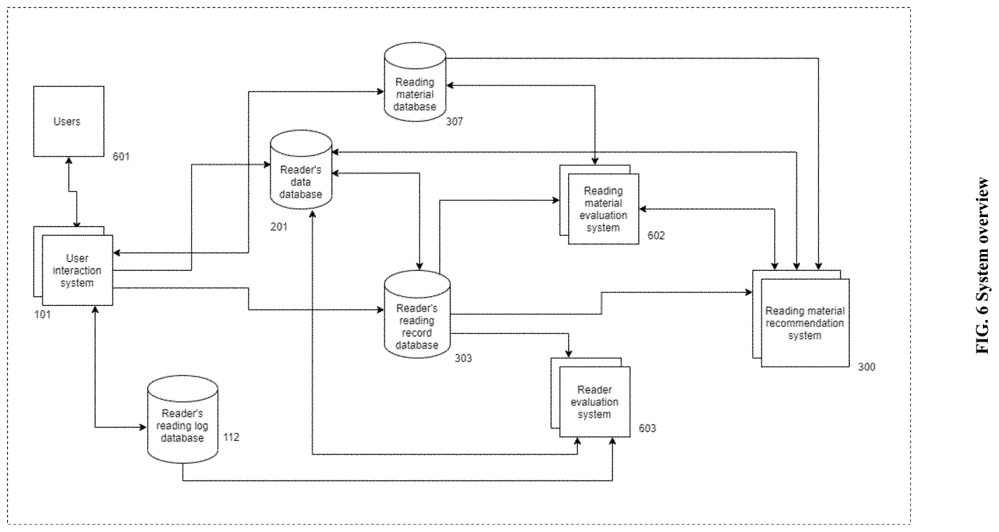

FIG. 6 describes the system overview. In this figure, four main databases interact with a couple of systems to help the reading material user with their readability index and their reading ability scores respectively. The User interaction system (601) interacts with all four databases, namely, the reader's reading log database (112), reader's reading record database (303), reader's data database (201) and lastly, the reading material database (307). Further, these databases interact with the three major systems, excluding the user interaction system (101), namely, the reading material evaluation system (602), the reader evaluation system (603) and the reading material recommendation system (300).

The user interaction system (101) sends and receives information to the reader's reading log database (112) which stores data which include but is not limited to the number of pages read by the reader, the time taken to finish the reading material. This information is then sent to the reader evaluation system (603) to get the reader's readability score. Similarly, the reader's reading record database (303) also stores information about the types of reading material read by the reader, the interests of the reader and information like such. This stored information is taken by the reading material recommendation system (300) so that the readability index of the reading material corresponds with the reading ability score of the reader.

The user interaction system (101) interacts with the reader's data database (201), which further interacts with the reader's reading record database (303) and the reading material recommendation system (300). The reader's data database (201) has the general information about the reader stored in it. This information helps to understand the level of comprehension of the reader when these various attributes are taken into consideration.

The user interaction system (101) further interacts with the reading material database (307) which then interacts with the reading material evaluation system (602) and the reading material recommendation system (300). This transfer of data helps to understand the readability index of a reading material.

1. Method of using computer aided systems for automatically calibrating any reading material (calibrated or uncalibrated) for its readability.

2. Method of using computer aided systems to automatically calibrating the reading ability of a reader.

3. Method of using computer aided systems to help a reader to improve their reading ability and to read regularly.

4. Method of claim 1, further comprises to statistically determine the reading material's readability index based on factors including but not limited to the readability levels of a cohort of readers who have read this reading material at a high level of comprehension.

5. Method of claim 1, further comprises to read the various readability measures of the reading material if such measures already exist for that material and estimating an initial readability index of the material based on such measures.

6. Method of claim 2 further comprises of estimating the reading level of a reader based on information received from the reader.

7. Method of claim 2, further comprises of, refining the estimates on reading level of the reader based on the readers comprehension of reading material read by the user.

8. Method of claim 3 further comprises to get them to read regularly by requiring them to update reading logs.

9. Method of claim 1, deciphers their reading comprehension based on the reading summaries they provide in their reading logs.

10. Method of claim 3 further comprises to challenge the reader to read material that is slightly above their current reading ability.

11. Method of claim 3, further comprises to encourage the reader to read material that is aligned with the area of interest or enjoyment for the reader.
